(19) United States
(12) Patent Application Publication
(10) Pub. No.: US 2013/0165015 A1
(43) Pub. Date: Jun. 27, 2013

(54) BEARING UNIT, YO-YO USING THE SAME, BALL BEARING UNIT AND YO-YO USING THE SAME

(71) Applicants: Haruo Sekido, Fujisawa-shi (JP); Hiroshi Nishizawa, Fujisawa-shi (JP)

(72) Inventors: Haruo Sekido, Fujisawa-shi (JP); Hiroshi Nishizawa, Fujisawa-shi (JP)

(73) Assignee: NSK LTD., Tokyo (JP)

(21) Appl. No.: 13/806,359

(22) PCT Filed: Feb. 22, 2012
(86) PCT No.: PCT/JP2012/054298

§ 371 Date: Dec. 21, 2012

(30) Foreign Application Priority Data
Dec. 21, 2011 (JP) 2011-279701

(51) Int. Cl. F16C 19/04; A63H 1/30

(52) U.S. Cl. CPC F16C 19/04; A63H 1/30
USPC 446/250; 384/543; 384/490

(57) ABSTRACT

An object of the present invention is to provide a yo-yo with a high rotary precision, capable of easily and reliably centering even in assembling or disassembling the yo-yo, using a bearing unit having a ball bearing with a simple configuration and high centering precision. A bearing unit (10) for a rotary toy includes: a shaft (15) including: a center portion (16) having a uniform shaft diameter corresponding to a width of an inner ring (12) of a ball bearing (11); and tapered portions (17) each extending from the center portion, each of the tapered portions being tapered toward an end portion thereof. The central portion (16) of the shaft (15) is fixed to the inner ring (12).

### TECHNICAL FIELD

The present invention relates to a bearing unit in which a shaft is fixed to an inner ring of a ball bearing that is accurately rotated at a low torque, and a yo-yo using the same. Specifically, the present invention relates to a bearing unit that can easily center with respect to the inner ring by providing a tapered portion having a center concentric with the inner ring in a shaft fixed to the inner ring of the ball bearing. Furthermore, the present invention relates to a high precision yo-yo which easily centers, by attaching halves corresponding to the tapered portion of the shaft of the bearing unit.

Furthermore, the present invention relates to a ball bearing that is used in a rotary toy. Additionally, the present invention relates to a yo-yo that uses the ball bearing.

### BACKGROUND ART

In the related art, it has been possible to realize this type of yo-yo by causing a fitting portion provided in a center portion of the halves to correspond to the inner ring of the ball bearing placed in the center portion to perform center position alignment of the halves and the ball bearing, and screwing and fixing screws placed inside the inner ring into both halves. Furthermore, components constituting the yo-yo are each considered so that maintenance can be individually performed, and thus, it has been possible to realize a yo-yo having individual characteristics by performing cleaning of parts, ball bearing oiling and tuning such as precise balance adjustment.

Furthermore, there have been various types of games using the yo-yo, and competitions test the way of obtaining a characteristic depending on the type and the shape of the yo-yo, and various characteristics such as balance characteristics. Events such as the long sleeper in which the rotation time from the start of rotation to stopping is contested, and performance events such as the cat's cradle are well-known.

For example, Patent Literature 1 discloses providing a continuous spherical concave surface on the outer ring of the bearing or fixing the halves using a screw to prevent position deviation due to the tangling of cord (string) wound around a core of the yo-yo.

In addition, Patent Literature 2 discloses a yo-yo in which screws are provided at both sides of the shaft, the halves are fixed to both sides using the screws, and a bearing is placed in a center portion of the shaft.

### CITATION LIST

### Patent Literature

[PTL 1] U.S. Pat. No. 7,175,500
[PTL 2] JP-A-2003-135859

### SUMMARY OF INVENTION

### Problem to be Solved by the Invention

However, in the yo-yo of the related art, when performing disassembling, cleaning or the like, and disassembling and reassembling the bearing and the halves, an axis center between a shaft center of the bearing and the halves changes slightly, the rotational balance is delicately changed, and in a long sleeper or the like, there has been a problem in that the rotation time has been decreased and the rotation (surface) run out of the halves has been changed. The reasons thereof will be specifically described with reference to FIG. 5 that illustrates a cross-sectional view of the bearing on the yo-yo.

In FIG. 5, halves 53 having high inertia are placed on both sides of a ball bearing 51 placed in the center portion of the yo-yo. In inner diameter portions 53a of the halves 53, the halves 53 are fixed to the inner ring of the ball bearing 51 from both sides via screws 52. Furthermore, the halves 53 are provided with fitting portions 54 that are positioned with respect to the inner ring of the ball bearing 51.

Although the fitting portions 54 of the halves 53 and the inner ring of the ball bearing 51 are fitted with a clearance in a disassemblable manner, if the clearance is large, center line between halves 53 and the ball bearing 51 will shift, and thus it is considered that the rotation time is decreased or the rotation run out of the halves is changed. Meanwhile, if the clearance is small, even if the screws 52 are loosened when disassembling by so-called stack-up, galling or the like, the fitting portions 54 of the halves 53 are tightly fitted to the inner ring of the ball bearing 51, and radio pliers having thin tips are mounted to a concave portion of the outer ring of the ball bearing 51 so that disassembling is difficult, and is detached by prying open.

For this reason, there has been a problem in that a an indentation (Brinnel indentation) is formed in a raceway (raceway groove) of the ball bearing 51 or the fitting portions 54 of the halves 53 to be shaved, and on the contrary, the gap is increased, difference of center line between the halves 53 and the ball bearing 51 is increased, and as a result, the rotation time is decreased and the rotation run out of the halves is changed.

Furthermore, when the left and right halves 53 have the same shape so as to combine, a fitting length (L in FIG. 5) of the fitting portions 54 of the halves 53 in an axial direction is equal to or less than halves of a width dimension B of the ball bearing 51. That is, the relationship B>2×L is accomplished and the fitting lengths are short, and thus it is understood that the positioning accuracy of the halves 53 decreases.

In addition, in the yo-yo of the related art, when disassembling and reassembling the ball bearing from the halves, the operation is performed in a state of gripping the outer ring of the ball bearing. Particularly, when removing the dirt on the outer ring of the ball bearing, the outer ring of the ball bearing is firmly gripped using non-woven fabric or the like by one hand, and the outer ring of the ball bearing is wiped by the other hand rubbing in a circumferential direction. Moreover, in the yo-yo described in Patent Literature 1 mentioned above, since the concave surface is uniformly provided on the outer peripheral surface of the outer ring of the ball bearing until reaching an end portion in an axial direction, both side portions of the outer peripheral surface of the outer ring in the axial direction have a sharp shape on both end. For this reason, a cross-sectional area is reduced toward the end, the allowable stress is exceeded during disassembling check work or the like, and thus chipping is easily generated. Moreover, when chipping is generated, non-woven fabric or the like is caught at both side portions of the outer peripheral surface of the outer ring in the axial direction, and thus the workability may decline. Furthermore, when performing disassembling, assembling or the like, it was unnecessarily determined that consideration should be given to stability in the yo-yo of the related art, and as a result it was necessary to pay attention to handling of the ball bearing, and thus the workability may decline.

Furthermore, depending on the operator, the impression of a sharp feeling is sternly received due to the sharpened shape, and thus the work itself may be avoided. Particularly, in a metallic ball bearing, in order to increase the characteristics of the ball bearing to the maximum level, a steel material is subjected to thermal treatments such as quenching and tempering to raise hardness, and thus this tendency is significant.

The present invention has been made to solve the above-mentioned problems, and a first object of the present invention is to provide a bearing unit in which it is possible to easily and accurately position of the halves with respect to the inner ring of the ball bearing even when performing disassembling and assembling, and a yo-yo having high rotary precision using the bearing unit.

Furthermore, a second object of the present invention is to provide a ball bearing that prevents catching due to non-woven fabric when performing disassembling and assembling even if the concave surface is formed on the outer peripheral surface of the outer ring, and is able to suppress the impression of a sharp feeling and excessive consideration of safety and promote an improvement of workability, and a yo-yo using the same.

### Means for Solving the Problem

In order to achieve the first object mentioned above, according to the present invention, there is provided a bearing unit for a rotary toy, comprising: a shaft comprising: a center portion having a uniform shaft diameter corresponding to a width of an inner ring of a ball bearing; and tapered portions each extending from the center portion, each of the tapered portions being tapered toward an end portion thereof, wherein the central portion of the shaft is fixed to the inner ring.

With this configuration, the shaft and the inner ring of the ball bearing are positioned throughout the entire length (a width dimension B) in the axial direction, and thus the accuracy can be raised. Furthermore, since the shaft and the inner ring of the ball bearing are fixed, even when disassembling and maintenance of the rotary toy are performed, this portion is not (cannot be) disassembled, and thus the relationship between the shaft and the inner ring is maintained in a state of favorable precision.

Furthermore, since the tapered portion is included in which both sides continued to the center portion of the shaft are narrowed toward the end, it is possible to substantially easily and accurately position the halves placed at the outside in the inner ring of the ball bearing using the tapered portion.

Furthermore, since the halves can be attached and detached without applying a large load to the inner ring of the ball bearing, it is also possible to prevent damage such as Brinnel indentation from being applied to the ball bearing.

Furthermore, the center portion of the shaft is fixed to the inner ring by interference fit, and a value of the interference fit is smaller than a radial gap of the ball bearing. With this configuration, when the shaft is mounted to the inner ring of the ball bearing, even if the radial gap is reduced due to the interference, the radial gap can be reliably secured, the rotary torque can be maintained at a low level, and the characteristics of the bearing unit can be secured. Thereby, the yo-yo having high rotary precision can be realized.

Furthermore, a gap is formed between the center portion of the shaft and the inner ring, and the center portion of the shaft is fixed to the inner ring by an adhesive filled in the gap, and the adhesive comprises a filler whose size is smaller than a radial gap of the ball bearing. With such a configuration, since there is no interference, changes in the radial gap of the ball bearing can be prevented. Thus, if the filler is scattered from the adhesive and enters inside the ball bearing, since the filler is smaller than the radial gap, the radial gap can be reliably secured. Thereby, characteristics of the bearing unit can be secured so that the rotation of the inner ring is not locked.

Furthermore, the ball bearing further comprises an outer ring, and the inner ring and the outer ring are made of martensitic stainless steel. With such a configuration, since rust preventive performance of the ball bearing can be enhanced, the application of rust preventive oil can be omitted. Thereby, the work in the maintenance is easy, the rust preventive oil can be prevented from being attached to the winding string, and thus scattering of the rust preventive oil to the circumference can also be prevented. In addition, it is possible to suppress the discomfort due to the attachment of preventive oil passed through the string.

Furthermore, according to the present invention, there is provided a yo-yo comprising: the bearing unit mentioned above; and halves each fitted with a corresponding one of the tapered portions. With this configuration, even when disassembling and assembling the yo-yo, the relationship between the shaft and the ball bearing is maintained in the good precision state, and the halves are positioned to the tapered portion of the shaft. Thus, the halves are substantially easily and accurately positioned with respect to the inner ring of the ball bearing, even when performing disassembling and assembling, it is possible to easily provide a yo-yo having high rotary precision.

Furthermore, the halves are removable from the bearing unit via a clamping means. With this configuration, since positioning and fastening of the halves can be performed separately, respective degrees of freedom can be increased, and it is possible to reduce the functions thereof from having an effect on each other. Thus, for example, there is no risk of an effect on the positioning precision of the halves due to the clamping condition in the clamping means.

Furthermore, each of the halves comprises a bush at a portion where each of the halves is fitted with the corresponding tapered portion, wherein the hardness of the bush is higher than that of the halves. With this configuration, even if the number of times of disassembling and assembling are increased, abrasion can be reduced by bushes having high hardness, the decrease of the positioning precision can be prevented, and thus the yo-yo having high rotary precision can be provided. In addition, since hardness is high, so-called stack-up, galling or the like can be reduced, and workability during disassembling and assembling can be improved.

Furthermore, the bush is made of martensitic stainless steel. With this configuration, since rust preventive characteristics are high and there is no need for a special rust preventive treatment, handling thereof is easy. Moreover, by forming the inner and outer rings of the ball bearing with the martensitic stainless steel, the thermal expansion coefficients thereof can be equal to each other, and thus it is possible to reduce changes in the rotary precision and torque due to temperature change.

Furthermore, in order to achieve the second object, according to the present invention, there is provided a ball bearing for a rotary toy comprising: an inner ring; an outer ring, wherein a concave surface is formed on an outer peripheral surface of the outer ring, the concave surface has the smallest outer diameter at an axial center position of the outer ring, and has a linear symmetric shape at the axial center position, and flat surfaces are formed at both axial sides of the concave surface such that the respective flat surfaces are perpendicular to end surfaces of the outer ring.

With this configuration, when the ball bearing is rotated, the friction state between the string and the outer ring due to the generated vibration or the like becomes kinetic friction. A coefficient of kinetic friction is lowered compared to a coefficient of static friction, and the string is moved to the axial center portion having the smallest outer diameter. For this reason, the outer ring of the bearing can be stably maintained. Furthermore, even when there is torsion in the string due to the concave surface, average positions of the outer ring and the string are near the axial center portion having the smallest outer diameter, and thus it is possible to stably support the rotating ball bearing by the string.

Furthermore, since flat surfaces perpendicular to the end surface of the outer ring are each formed at both axial sides of the concave surface, it is possible to substantially set an angle formed between the both axial side portions of the outer peripheral surface and the end surface of the outer ring to an obtuse angle. For this reason, even if the concave surface is formed on the outer peripheral surface of the outer ring, when performing disassembling or assembling, catching due to non-woven fabric or the like can be prevented, and it is possible to suppress the impression of a sharp feeling and excessive safety consideration and promote the improvement of workability.

Furthermore, an axial center portion of the concave surface is formed in a parabolic shape or an arc shape. With this configuration, when the ball bearing is rotated, an imaginary tangential line between the shaft (the rotation shaft) of the ball bearing and the axial center portion of the outer ring is in a parallel positional relationship when viewed from a cross-section. Thereby, the rotational shaft can be stably supported by the string. Furthermore, the axial center portion of the concave surface becomes a bottom, the imaginary tangential line to the bottom is zero when viewed from the cross-section, and the outer diameter is monotonically increased with separation from the bottom. For this reason, it is possible to stably support the string in the axial center portion having the small outer diameter, meandering of the string can also be reduced, and thus it is possible to realize the rotary toy having high rotary precision.

Furthermore, the inner ring and the outer ring are made of martensitic stainless steel. With this configuration, since the rust preventive characteristics of the ball bearing can be enhanced, the application of rust preventive oil can be omitted. Thereby, the work in the maintenance is simple, and the attachment of rust preventive oil to the winding string, and thus scattering of rust preventive oil to the circumference can be prevented. In addition, it is also possible to prevent discomfort due to the attachment of rust preventive oil to a finger via the string. In addition, by forming the inner ring and the outer ring of the ball bearing with martensitic stainless steel, the coefficient of thermal expansion can be equalized, and it is possible to reduce the rotary precision and the change of the rotary torque due to the temperature change.

Furthermore, there is provided a yo-yo comprising: the ball bearing mentioned above; and halves provided at axial both sides of the ball bearing. With this configuration, it is possible to reduce twist of the string wrapped around the yo-yo and prevent position deviation. Thereby, it is possible to realize the yo-yo capable of obtaining the stable rotation. In addition, even if the concave surface is formed on the outer peripheral surface of the outer ring of the ball bearing, when disassembling or assembling the yo-yo, it is possible to prevent catching due to non-woven fabric or the like, suppress the impression of a sharp feeling and excessive safety consideration, and promote an improvement of workability. For this reason, it is possible to realize the yo-yo in which the maintenance is easy and workability is improved.

Furthermore, the halves are removable from the ball bearing. With this configuration, it is possible to improve a degree of freedom of selection of the halves and to respectively prepare a yo-yo that is suitable for each game. Furthermore, by suitably selecting the characteristics of the ball bearing and the characteristics of the halves to make a new combination, it is possible to cope with various games, and thus it is possible to increase variety of the game item in which the yo-yo can be used.

### Advantageous Effects of Invention

According to the bearing unit of the present invention, since the shaft and the inner ring of the ball bearing are fixed, even when performing disassembling and assembling of the rotary toy, the relationship between the shaft and the inner ring is maintained in the good precision state. Furthermore, when forming the yo-yo using the bearing unit, by fitting the halves and the shaft to each other using the tapered portion, it is possible to simply and reliably make the shaft and the shaft center of the halves coincide with each other, deviation of the center line between the halves and the ball bearing can be reduced, and the yo-yo having high rotary precision can be realized.

Furthermore, according to the ball bearing of the present invention, since the both axial end side portions of the concave surface of the outer ring of the ball bearing are each formed with flat surfaces perpendicular to the end surface of the outer ring, it is possible to substantially set the angle formed between the both axial side portions of the outer peripheral surface and the end surface of the outer ring to an obtuse angle. For this reason, even when the concave surface is formed on the outer peripheral surface of the outer ring, when performing disassembling and assembling, it is possible to prevent catching due to non-woven fabric or the like, and it is possible to suppress the impression of a sharp feeling and excessive safety consideration and promote an improvement of workability.

### BRIEF DESCRIPTION OF DRAWINGS

FIG. 1 is a cross-sectional view of a yo-yo according to a first embodiment of the present invention.

FIG. 2 is an enlarged view of an A portion around a bearing unit of FIG. 1.

FIG. 3 is a cross-sectional view that describes fitting between a shaft and halves.

FIG. 4 is a cross-sectional view of a ball bearing according to the first embodiment of the present invention.

FIG. 5 is a cross-sectional view of major portions of the bearing portion of the yo-yo of the related art.

FIG. 6 is a cross-sectional view of a ball bearing according to a fifth embodiment of the present invention.

FIG. 7 is an enlarged view of an E portion around a bearing unit of FIG. 6.

FIG. 8 is a cross-sectional view of the ball bearing according to the fifth embodiment of the present embodiment.

FIG. 9 is an enlarged view of a C portion around a ball bearing of FIG. 8.

FIG. 10 is a diagram that describes an effect of a flat surface according to the fifth embodiment of the present invention.

FIG. 11 is an enlarged view of major portions that describe a modified example of the fifth embodiment.

FIG. 12 is a cross-sectional view of a ball bearing of another yo-yo of the related art.

FIG. 13 is an enlarged view of a D portion of a ball bearing of FIG. 12.

### DESCRIPTION OF EMBODIMENTS

Hereinafter, embodiments according to the present invention will be described with reference to the drawings in detail.

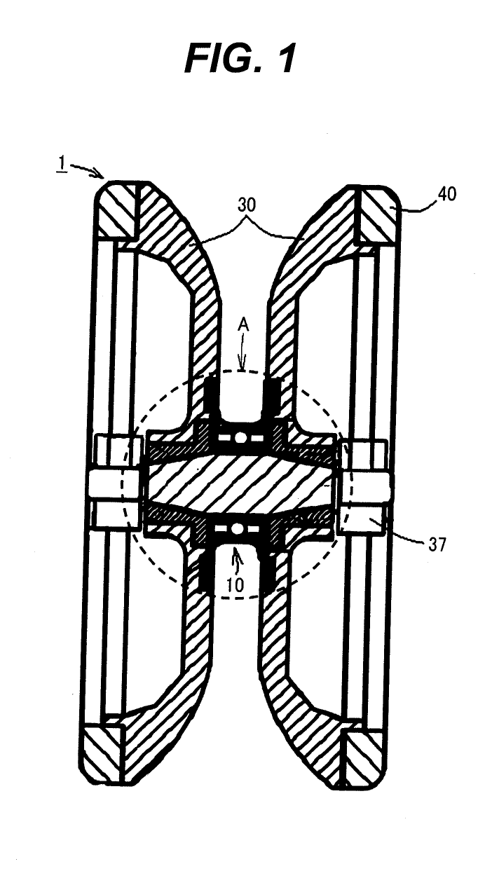

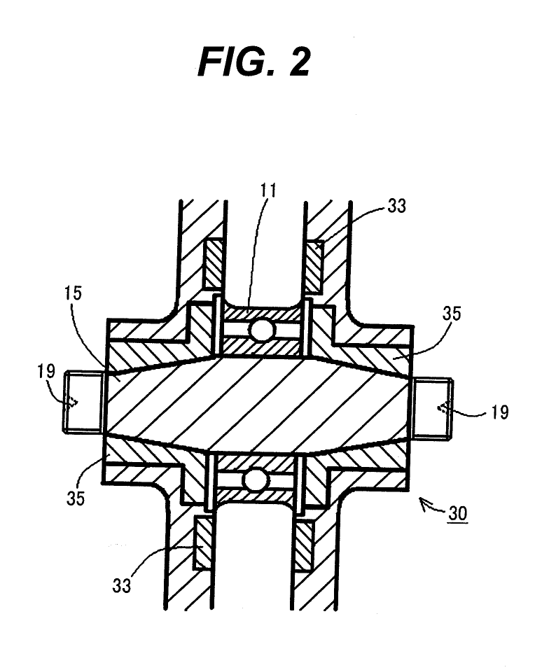

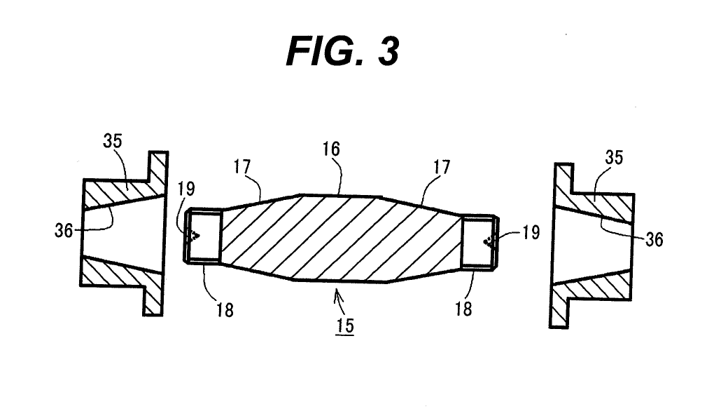

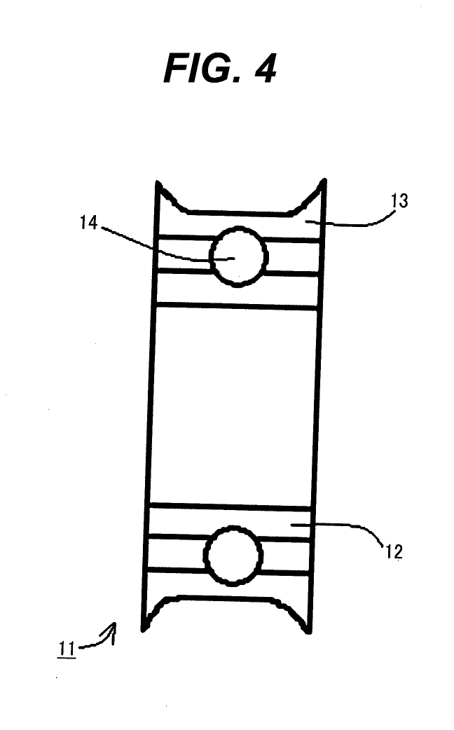

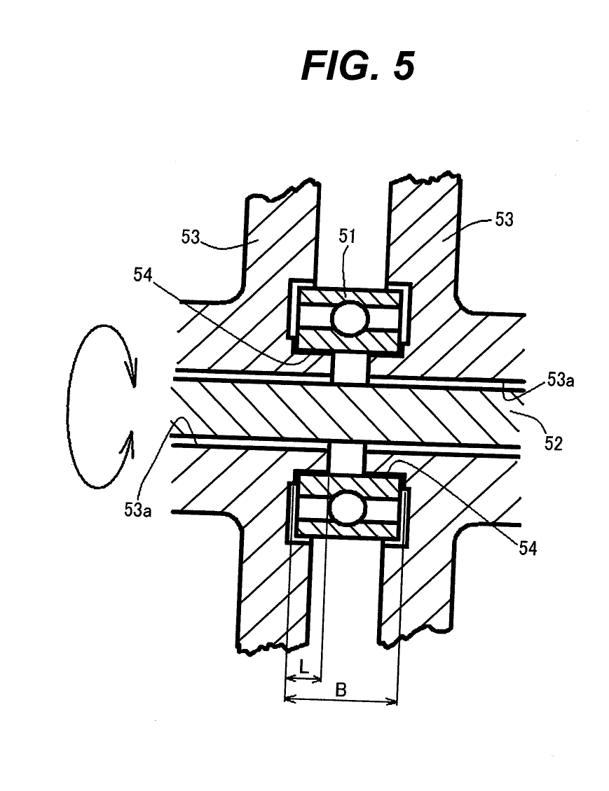

FIG. 1 is a cross-sectional view of a yo-yo according to a first embodiment of the present invention, FIG. 2 is an enlarged view of an A portion around a bearing unit of FIG. 1, FIG. 3 is a cross-sectional view that describes fitting between a shaft and halves, and FIG. 4 is a cross-sectional view of the ball bearing.

### First Embodiment

As illustrated in FIG. 1, a bearing unit according to the first embodiment of the present invention, and a yo-yo using the bearing unit as a rotary toy are configured so that halves 30 having large diameters are attached to both sides of a bearing unit 10 provided in a central portion, and inertia rings 40 made of a material having high density and high inertia are attached to outer peripheral portions of the halves 30 to form the yo-yo 1. A twisted thread referred to as a string not illustrated is wound around the outer periphery of the bearing unit 10 to give the yo-yo the rotational movement and perform games of various items.

Next, the bearing unit 10 will be described in detail using FIGS. 2 and 3. The bearing unit 10 is configured so that a center portion 16 of a shaft 15 is mechanically fixed into an inner ring 12 of a ball bearing 11 as press fit manner. The diameter of the center portion of the shaft 15 is straight, and a length thereof corresponds to a width dimension of the ball bearing 11. Both side portions continued to the center portion 16 of the shaft 15 are provided with a tapered portion 17 whose diameter is gradually decreased toward the end.

At the tip of the tapered portion 17, a screw 18 and a center hole 19 coaxially with the end surface are provided. It is possible to mount the halves 30 to the tapered portion 17 and fix the components by a nut 37 serving as clamping means. Center portions of the halves 30 are provided with bushes 35, and inner diameter portions 36 of the bushes 35 are provided with the same taper as the tapered portion 17 of the shaft 15. Furthermore, a friction plate 33 using a silicone rubber for winding the string around the halves 30 is provided near the ball bearing 11 of the halves 30.

Next, the ball bearing 11 will be described using FIG. 4. In FIG. 4, the inner ring 12, the outer ring 13 and balls 14 serving as rolling elements are made of SUS 440C of martensitic stainless steel or equivalent. The components are machined into a required shape, and thermal treatments such as quenching and tempering, and are finished into a final shape by polishing or the like. Since SUS 440C is used, compared to high carbon chromium bearing steel such as normal SUJ2, the rust preventive characteristics are high, and thus the components can be used under a normal environment without applying rust preventive oil.

The balls 14 are placed at substantially equal intervals at required positions by a retainer not illustrated. Compared to a general ball bearing, the balls 14 greatly differ in that the concave surfaces are formed on the outer surface of the outer ring 13. Lubricant oil or grease is applied or charged between the inner ring and the outer ring if necessary.

As an example, the lubricant oil is made by adding the additives for improving the required characteristics as a PAO (poly α olefin) base. It is also possible to add nanoparticles using elements such as fullerene or a platinum group that indicates a strong antioxidant action with respect to a highly reactive radical such as active oxygen.

Although a rough dimension of the ball bearing 11 is configured so that the outer diameter×the inner diameter×the width (D×d×B) is 12.7×6.35×4.762 [mm] (½×¼× 3/16 [inches]), and the numbers of the ball 14 are odd numbers such as 9, 11, and 13 to 15, the numbers can be suitably selected. The degree of accuracy of the ball bearing 11 is ABEC 5 or more and the radial gap is 5 to 10 μm. As a shield not illustrated, a double-sided shield is used.

However, next, assembling of the bearing unit 10 and the yo-yo 1 will be described. Firstly, in the bearing unit 10, a width dimension of the inner ring 12 of the ball bearing 11 mentioned above is 4.762 [mm], and the center portion 16 of the mounted shaft 15 has the same length corresponding to the dimension. Thereby, compared to the bearing portion of the yo-yo of the related art mentioned above, since more than twice the fitting length (the inner ring width B) can be obtained, it is possible to accurately assemble the shaft center of the ball bearing 11 and the shaft center of the shaft 15. In addition, the dimension of the center portion 16 of the shaft 15 corresponding to the inner ring width is not limited to the same length as the inner ring width, but is arbitrary in a range in which the center of the ball bearing 11 and the shaft center of the shaft 15 can be accurately assembled.

A material of the shaft 15 is SUS 303 in this embodiment, and the diameter of the center portion 16 has a dimension in which an interference is set to be smaller than the radial gap of the ball bearing 11. Thereby, although the radial gap is reduced when the shaft 15 is fitted into the inner ring 12 in a press-fit manner, it is possible to reliably prevent the radial gap from disappearing after the pressure-fit.

In addition, since both side portions continued to the center portion 16 of the shaft 15 are provided with tapered portions 17 in which the diameter becomes smaller toward the end, guidance is performed during press-fitting, galling or the like can be prevented, and thus workability can also be improved. Moreover, it is possible to reduce the coefficient of friction and further soften the pressure-fitting by applying little amount of fast drying punching oil or the like onto the surface of the shaft 15 during fitting. Since the oil also has fast drying characteristics, the oil does not have an effect after fitting and therefore, is convenient.

In addition, removing force is sufficiently obtained by setting the interference fit to a high level using a ball bearing that is greater than the radial gap, and it is also possible to provide a partial relief groove on the center portion 16 of the shaft 15 with respect to the width of the inner ring 12. The relief groove of this case is able to prevent deformation of a rolling groove (not illustrated) called a raceway on which the balls 14 run by being provided in the center portion in which the thickness of the inner ring 12 is the thinnest, and thus it is possible to further smoothen the rotation of the inner ring 12.

In this way, by mechanically fixing the ball bearing 11 and the shaft 15, the bearing unit 10 can be assembled. After that, if necessary, rotational torque, run out, acoustic noise measure using an Anderon meter or the like can be performed.

Next, assembling as the yo-yo will be described. It is known that disassembling, cleaning, adjustment and the like of this type of competition yo-yo is performed each time it is used or on a regular basis, and is maintained to have favorable characteristics for the contestant. Thus, in assembling, it is important that expected characteristics are always stable and are maintained.

That is, even if assembling is performed several times, it is required that the relationship between the ball bearing 11, the shaft 15 and the halves 30 is formed in the same manner. More specifically, the shaft 15 and the halves 30 can be positioned and be assembled with respect to the center of the ball bearing 11 in the high precision state. Thereby, the balance during rotation can be maintained well, and thus it is possible to reliably prevent the change of the rotation time and the changed of the rotation run out of the halves.

With the bearing unit 10 mentioned above, it is possible to precisely adjust the shaft center of the ball bearing 11 with the shaft center of the shaft 15, and due to the mechanical fixing, there is no need to disassemble the ball bearing 11 and the shaft 15. Thus, it is possible to always maintain the relationship between the ball bearing 11 and the shaft 15 in the same condition.

However, in the center portions of the halves 30 are provided with bushes 35, and inner diameter portions 36 of the bushes 35 are provided with the taper of the same dimension as that of the taper provided in the tapered portion 17 of the shaft 15. In the present embodiment, the halves 30 is made of aluminum (A5052 or the like), and the bushes 35 is made of SUS 303 which is the same material as the shaft.

Although aluminum is light due to low density, it is relatively soft. Thus, when aluminum is used for such as fitting portion, aluminum is easily worn, so that mechanical play and stuck up and galling is easily generated. Furthermore, in order to lengthen the rotation time, since it is required that the halves are light and have large inertia, in the present embodiment, the halves are realized by combining the light halves 30 and the inertial ring 40 having large inertia.

As mentioned above, the inertial ring 40 uses brass (C2600 or the like) as a material having high density, and is accurately fixed to the center shaft of the halves 30 for centering.

Next, centering using the tapered portion 17 of the shaft 15 of the bearing unit 10 and the inner diameter portion 36 of the bush 35 will be described. In the tapered portion 17 and the inner diameter portion 36 of the bush 35, tapers having the same gradient as the same taper are formed with respect to the shaft and the hole.

In the present embodiment, a linear taper (tan θ is fixed) is adopted, about values of 1/50 to ¼ are suitable, more preferably, about 1/20 to ⅕, and the values can be suitably selected. In addition, the shape of the taper can also use an exponential function, a parabola or the like in addition to the linear taper as in the present embodiment.

Regarding a diameter dimension of the fitting portion, the inner diameter portion 36 side of the bush 35 is slightly smaller than the outer diameter of the tapered portion 17, and fitting is stopped in the middle of the tapered portion 17 of the shaft. When the dimensions of the bush inner diameter and the outer diameter of the tapered portion of the shaft are slightly changed, a position, where fitting is stopped in a state where the center axes of the shaft and the bush are precisely positioned, is moved only in the axial direction. An amount of the movement is determined by an amount corresponding to the difference of the dimensions and the taper.

When mounting to the halves 30 having the bushes 35 in the inner diameter to the bearing unit 10 and axially moving the bearing unit 10 and the halves 30, the center axes of the shaft and the bush are precisely positioned, and are stopped at a position corresponding to the finish diameter. In this state, when being fastened by the nut 37, the halves 30 are easily and accurately positioned and can be fixed.

### Second Embodiment

Next, a second embodiment of the present invention will be described. In the present embodiment, the inner ring 12 and the center portion 16 of the shaft 15 have gaps, and are fixed by an adhesive (not illustrated) filled in the gaps.

As mentioned above, the adhesive is anaerobic and smaller gap usage type and contains filler (not illustrated) that is smaller than the radial gap of the ball bearing 11. The filler having a spherical shape and an average diameter of substantially 50 nm is used. Although a particle size distribution is not particularly defined, but the maximum particle diameter needs to be smaller than the radial gap of the ball bearing 11. The material, the shape and the dimension of the filler can be suitably selected.

Regarding a curing reaction, additionally, by jointly using one in which the initiator is operated by heat, ultraviolet or the like, curing of the excessive adhesive can also be performed.

In the present embodiment, since there is no interference fit, it is possible to reliably prevent the change of the radial gap of the ball bearing. Furthermore, since stress applied to the inner ring 12 can be small and equalized, characteristics in a simple substance of the ball bearing 11 is maintained substantially as it is. Furthermore, even if the filler contained in the adhesive is scattered and enters the ball bearing 11, since the filler is smaller than the radial gap, the radial gap does not disappear, and the inner ring 12 is not locked.

### Third Embodiment

Next, a third embodiment in the present invention will be described. In the present embodiment, the inner ring 12, the outer ring 13 and the shaft 15 of the ball bearing 11 are formed of martensitic stainless steel. More specifically, the components are formed of SUS 440C and, by forming the ball bearing 11 and the shaft 15 by the same material, the coefficient of thermal expansions thereof can be equal to each other.

Thereby, it is possible to reliably prevent the change of characteristics due to the slight dimension change accompanied by the temperature change, and it is possible to improve the temperature characteristics of the bearing unit 10 and the yo-yo 1. Furthermore, by also forming the bush 35 by the same material, the temperature characteristics can be further improved.

### Fourth Embodiment

Next, a fourth embodiment in the present invention will be described. In the present embodiment, it is possible to simply and easily confirm and adjust the rotational balance using a center hole 19 provided at the same shaft as the center axis of the shaft 15 on the end surface of the screw 18 at both ends of the shaft 15.

The halves 30 including the inertial ring 40 are assembled to the bearing unit 10, and after assembling and finishing the halves 30 or bearing unit 10 as the yo-yo 1, the center hole 19 is supported from both sides through the hole provided in the center of the nut 37 using a bench center not illustrated from the outside. Since the yo-yo 1 is fixed by the center hole 19, by lightly turning the halves 30 by hand to observe the end surface run out or the like of the halves 30, it is possible to simply confirm the rotation balance of the finished yo-yo 1.

From the phase or size of the rotation, by suitably attaching a counter weight for correcting the balance to the halves 30 to correct the balance while being confirmed, it is possible to simply realize the yo-yo having higher precision.

### Fifth Embodiment

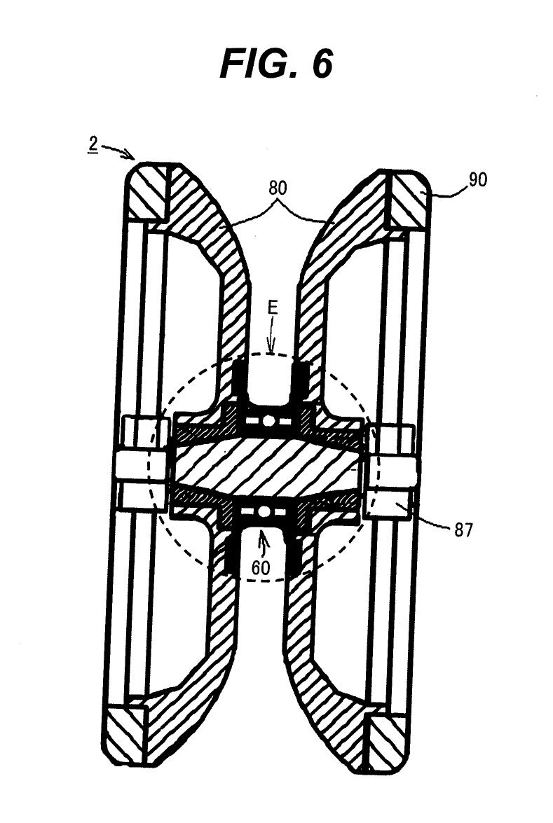

As illustrated in FIG. 6, a bearing unit 60 according to the fifth embodiment of the present invention and a yo-yo 2 as a rotary toy using the bearing unit 60 are configured so that halves 80 having large diameters are attached to both sides of the bearing unit 60 provided in the center portion, inertia rings 90 made of a material having high density and high inertia are attached to outer peripheral portions of the halves 80 to form the yo-yo 2. A twisted thread called a string not illustrated is wound around the outer periphery of the bearing unit 60 to give the rotary movement to the yo-yo and perform games of various items.

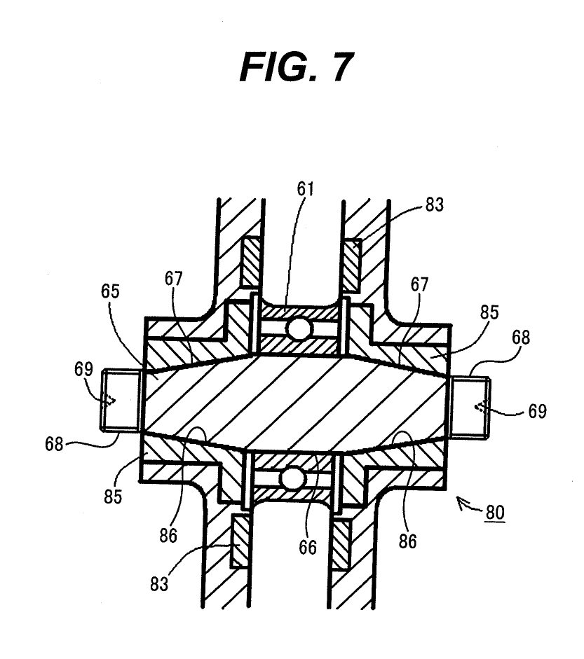

The bearing unit 60 will be described in detail using FIG. 7. The bearing unit 60 is configured so that a shaft 65 is pressure-fitted and fixed to an inner ring 62 of a ball bearing 61. A center portion 66 of the shaft 65 has a straight diameter, and a length thereof corresponds to a width dimension of the ball bearing 61. Both side portions continued to the center portion 66 of the shaft 65 are provided with tapered portions 67 whose diameters are gradually decreased toward the end.

Furthermore, a screw 68 is provided in a leading end portion of the shaft 65. Thereby, it is possible to mount and fix the halves 80 to the tapered portions 67 using the nut 87 serving as clamping means (see FIG. 6). Furthermore, at the leading end surface of the shaft 65, the center hole 69 is provided in the same shaft.

Furthermore, bushes 85 are provided in the center portions of the halves 80, and the same tapers as the tapered portions 67 of the shaft 65 are provided in the inner diameter portions 86 of the bushes 85. Thereby, halves 80 have configurations that are positioned between the tapered portions 67 of the shaft 65. Furthermore, a friction plate 83 using a silicone rubber or the like for winding the string around the halves 80 is provided near the ball bearing 61 of the halves 80.

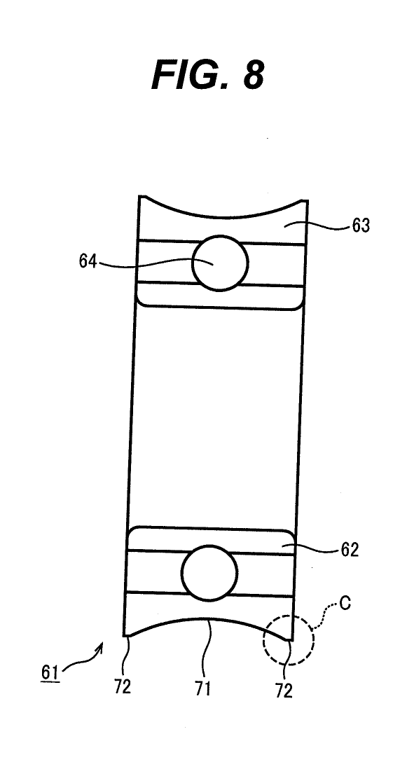

Next, the ball bearing 61 will be described using FIG. 8. In FIG. 8, the inner ring 62, the outer ring 63 and a ball 64 as a rolling element are made of SUS 440C of martensitic stainless steel or an equivalent. The components are machined into a required shape, then are subjected to thermal treatment such as quenching and tempering, and are finished into a final shape by polishing or the like. Since SUS 440C is used, compared to high carbon chromium bearing steel such as normal SUJ2, rust preventive characteristics are high, and thus the components can be used under a normal environment without applying rust preventive oil.

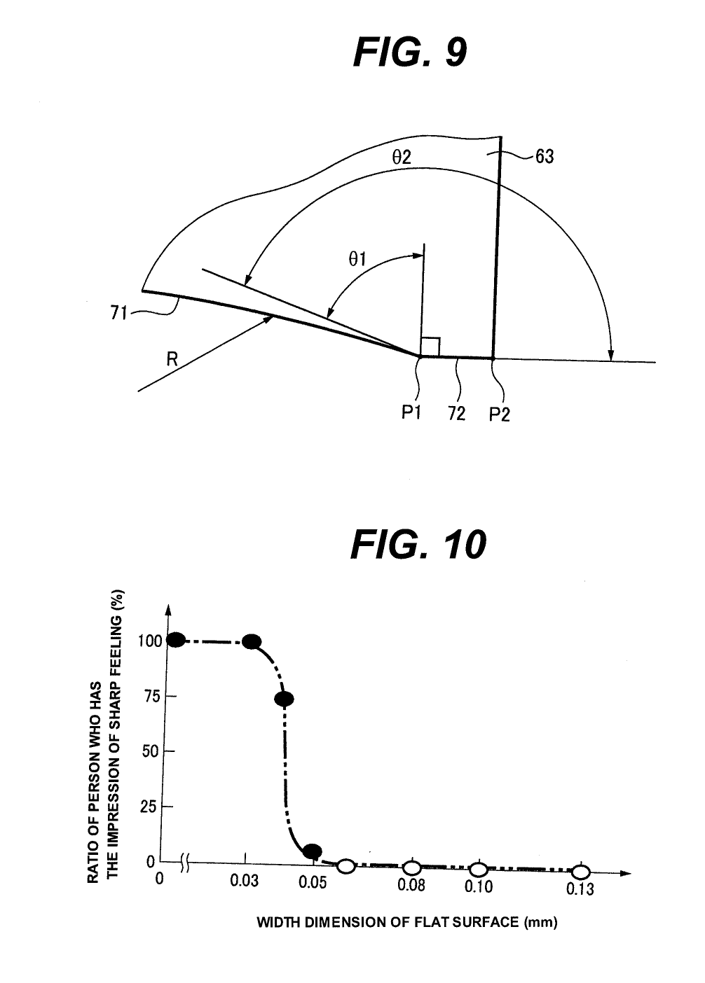

The balls 64 are placed at substantially equal intervals at required positions by a retainer not illustrated. Compared to a general ball bearing, the balls 64 greatly differ in that the concave surfaces 71 are formed on the outer surface of the outer ring 63. The concave surface 71 is formed in a parabolic shape or an arch shape, an outer diameter in the axial center portion is the smallest, and the concave surface is formed so as to have a linear symmetric shape at the axial center position. Furthermore, at the both axial sides of the concave surface 71, flat surfaces 72 perpendicular to the end surface of the outer ring 63 are each formed (see FIG. 9). In addition, lubricant oil or grease is applied or charged between the inner ring 62 and the outer ring 63 if necessary.

As an example, the lubricant oil is made by adding the additives for improving the required characteristics as a PAO (poly α olefin) base. It is also possible to add nano-size particles using elements such as fullerene or the platinum group that indicates the strong antioxidant action with respect to a high reactive expensive radical such as the active oxygen.

Although a rough dimension of the ball bearing 61 is configured so that an outer diameter×an inner diameter×a width (D×d×B) is 12.7×6.35×4.762 [mm] (½×¼× 3/16 [inches]), and the numbers of the ball 64 are 8, 9, 11, 12 and 13 to 15, the numbers can be suitably selected. The degree of accuracy of the ball bearing 61 is ABEC 5 or more and the radial gap is 5 to 10 μm. As a shield not illustrated, a double-sided shield is used.

However, next, assembling of the bearing unit 60 and the yo-yo 2 will be described. This type of competition yo-yo 2 performs disassembling, cleaning, adjustment or the like at every use and regularly. Thereby, the yo-yo 2 is maintained to become the more favorable characteristic of the contestant. Furthermore, in the present embodiment, as mentioned above, since the tapered portion 67 is provided in the shaft 65, and the inner diameter portion 86 of the bush 85 is formed in a shape corresponding to the tapered portion 67, only by placing and assembling the halves 80 at both axial sides of the ball bearing 61, the reliable positioning and stable characteristics can be obtained. Thereby, it is possible to prevent the change of the rotational time and the change of the rotational surface run-out of the halves 80. Furthermore, it is possible to easily attach the halves 80 to the bearing unit 60 in an attachable and detachable manner.

In this manner, since it is possible to easily disassemble and assemble the halves 80, the delicate balance for each half 80 can be easily taken, and the performance in the competition can be improved.

Furthermore, the ball bearing 61 is an important component that controls rotary characteristics of the yo-yo 2. For this reason, in the maintenance work of the ball bearing 61, in addition to cleaning of the ball bearing 61, the application of oil, and grease charging, adjustment of oil and grease, the consideration of the applying method or the like are performed. In addition, disassembling, cleaning, assembling or the like of the ball bearing 61 itself are also performed. In this case, an extreme care is paid whether or not the scratch and/or dent portion is generated on the rolling surfaces of the inner ring 62 and the outer ring 63 of the ball bearing 61, and on the surface of the ball 64.

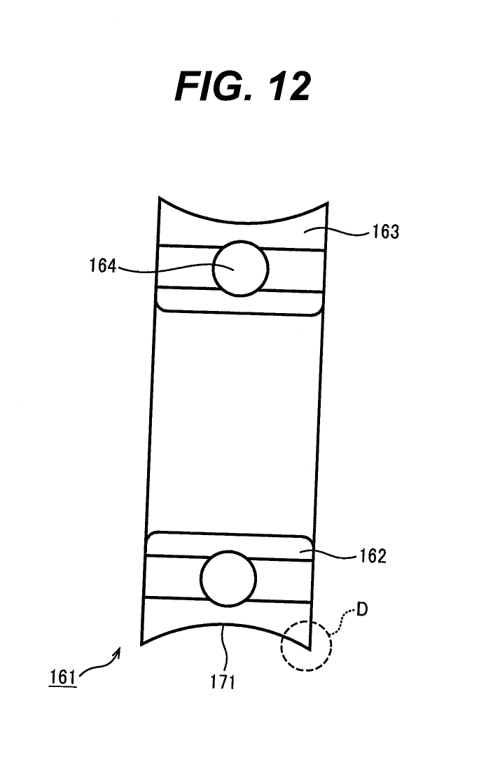

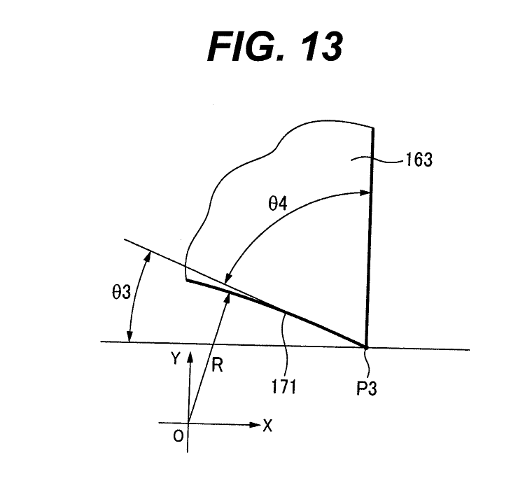

Next, in order to clarify the technical significance of the present invention, shapes of the both axial side portions of the outer peripheral surface of the outer ring in the ball bearing of the related art will be described with reference to FIGS. 12 and 13.

As illustrated in FIG. 12, a ball bearing 161 of the related art is constituted to having an inner ring 162, an outer ring 163 and a ball 164 as a rolling element. A rough dimension of the ball bearing 161 is 12.7×6.35×4.762 [mm] (½×¼× 3/16 [inch]) as the outer diameter×the inner diameter×the width (D×d×B). Furthermore, a concave surface 171 is formed on the outer peripheral surface of the outer ring 163. The concave surface 171 is machined by grinding or polishing after performing the thermal treatment of the outer ring 163, has a continuous arc until reaching the end surface of the outer ring 163 and a curvature thereof is set to 5.715 [mm] (0.225 [inch]).

As illustrated in FIG. 13, the external shapes at the both axial side portions of the outer peripheral surface of the outer ring 163 has shapes having a sharpened leading end. The sharpened shape can be expressed by an angle that is formed between an virtual tangential line in the edge portion (a point P3 in FIG. 13) of the concave surface 171 and the end surface of the outer ring 163. Thus, the shape will be geometrically examined. As illustrated in FIG. 13, when setting an XY coordinate system when viewed from the cross-section, the next equation is derived regarding the shape of the concave surface 171 based on an equation of circles. However, R of the next equation is a curvature (R=5.715 [mm]) of the concave surface 171.

X²+Y²=R² (1)

Furthermore, as an equation of straight line corresponding to the end surface of the outer ring 163, the next equation is derived. However, B of the next equation is a width dimension (B=4.762 [mm]) of the outer ring 163.

X=B/2 (2)

Next, an intersection point between equation (1) and equation (2), that is, a gradient of an virtual tangential line in a point P3 when viewed from a cross-section is found. For that reason, firstly, when transforming equation (1), the following equation is obtained:

Y=(R²−X²)^{1/2} (3)

Next, when differentiating equation (3) with X, the following equation is obtained.

dY/dX=−2X·(½)·1/(R²−X²)^{1/2} (4)

Next, when substituting X=B/2=2.381 [mm] and R=5.715 [mm] for equation (4), the following equation as the gradient of the virtual tangential line in the point P3 is obtained.

dY/dX_{x=2.381}≅−0.458 (5)

Thereby, an angle θ3 formed between the virtual tangential line and the X axis in the point P3 is obtained the following equation:

θ3=tan⁻¹(0.458)≅25° (6)

In addition, an angle θ4 formed between the virtual tangential line and the end surface of the outer ring 163 in the point P3 is obtained by the following equation:

θ4=∠R−θ3=90°−25°=65° (7)

In this manner, it is understood that the leading end portion is a sharp shape of 65° in the external shape of the both axial side portions of the concave surface 171 of the outer ring 163 of the ball bearing 161 of the related art.

Next, before a sensory test (described later) whether or not an impression of a sharp feeling is given to a person, a physical confirmation test was performed. Specifically, one of the both axial side portions of the outer peripheral surface of the outer ring 163 of the related art was pressed to a copy paper and a confirmation test whether or not the paper is cut was performed. In addition, the copy paper used in the confirmation test is an article number of GAAA5009 V-Paper (registered trademark) manufactured by Fuji Xerox Inter Field Corporation, and a rough specification is ISO brightness of 82%, and a weighing of 64 g/m².

Five sheets of the copy papers were stacked on a table made of steel, and load of around 50 N was applied to one of the both axial side portions of the outer peripheral surface of the outer ring 163 from the top thereof, and the one of the both axial side portions was caused to slide in a paper surface direction. Among the five sheets of copy papers, the uppermost paper was cut, the passed trace was clearly left in the second paper from the top, and the trace was slight left in the third paper.

Thereby, in the outer ring 163 of the related art, when disassembling and assembling the yo-yo, it is presumed that the impression of a sharp feeling is strongly given by the outer peripheral surface of the outer ring 163. For this reason, when performing cleaning for removing the dirt of the outer ring 163 of the related art, since the ball bearing 161 is wiped and rubbed by hand in the circumferential direction, a sense of unease is felt during work. Thus, in the outer ring 163 of the related art, when disassembling or assembling the yo-yo, due to excessive safe consideration, workability may decline.

Meanwhile, in the present embodiment, as illustrated in FIG. 9, at the both axial sides of the concave surface 71, flat surfaces 72 perpendicular to the end surface of the outer ring 63 are respectively formed.

Herein, as illustrated in FIG. 9, when setting the edge portion (a point in which the concave surface 71 intersects with the flat surface 72) to the point P1 when viewed from the cross-section, and the intersection point between the flat surface 72 and the end surface of the outer ring 63 to the point P2, the angle θ1 formed between the virtual tangential line and the Y axis in the point P1 is set to about 65°. That is, in the present embodiment, since the flat surfaces 72 are provided, the angle θ2 formed between the virtual tangential line and the flat surface 72 in the point P2 is about 155° (65°+90°). Thereby, the shape in the both axial side portions of the outer peripheral surface of the outer ring 63 of the ball bearing 61 is a shape that has a sufficient obtuse angle but not a shape with a sharp leading end. Thus, when performing disassembling and assembling, catching due to the non-woven fabric or the like is prevented, and it is possible to suppress the sharp feeling and excessive safety consideration and promote an improvement of workability.

Next, the sensory test of twenty persons randomly extracted was performed in regard to the presence or absence of the sharp feeling. In the sensory test, the width dimension of the flat surface 72 was changed, the outer peripheral surface of the outer ring 63 was actually touched, and a question was performed whether or not the impression of a sharp feeling is felt. The settled result is a graph illustrated in FIG. 10. In addition, in FIG. 10, the width dimension of the flat surface 72 is illustrated in a horizontal axis thereof, and a ratio of a person who has the impression of a sharp feeling is illustrated in a vertical axis thereof.

As illustrated in FIG. 10, when the width dimension of the flat surface 72 is equal to or less than 0.03 mm, everyone had the impression of the sharp feeling, and the ratio thereof was 5% in the case of 0.05 mm. Furthermore, when the width dimension of the flat surface 72 is equal to or greater than 0.06 mm, it was understood that the ratio having the impression of the sharp feeling was zero. Thereby, by setting the width dimension of the flat surface 72 to substantially 0.06 mm or more also in consideration of the width dimension of the outer ring 63, it was understood that it is possible to substantially reliably suppress the impression of the sharp feeling. Although it is considered that the situation is changed due to characteristics such as elasticity of the skin surface, a material, hardness, and a shape of an opposite material or the like, in the case of the flat surface 72 of the ball bearing 61, it is considered that the suppression of the impression of the sharp feeling can be realized by 0.04 to 0.05 mm in the case of the flat surface 72 of the ball bearing 61.

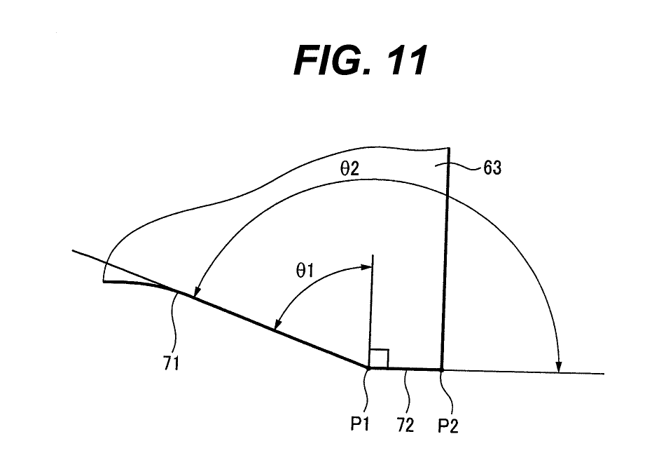

Furthermore, as a modified example of the present embodiment, in the embodiment mentioned above, although the concave surface 71 had the single parabolic shape or the arc shape, as illustrated in FIG. 11, the concave surface 71 may be configured so that the axial center portion thereof has the parabolic shape or the arc shape, and the axial outer portion further than the center portion has a straight line shape that is monotonously increased, without being limited thereto. In this case, since the string can be stably supported by the center portion having a small outer diameter, meandering or the like of the string can be reduced, and thus the stable rotation can be obtained.

### Sixth Embodiment

Next, a sixth embodiment of the present invention will be described. In the present embodiment, compared to the fifth embodiment, the inner ring 62 and the outer ring 63 of the ball bearing 61 and the shaft 65 are formed of a martensitic stainless steel. More specifically, the components are formed of SUS 440C, and by forming the ball bearing 61 and the shaft 65 by the same material, it is possible to make the coefficient of thermal expansion the same.

Thereby, it is possible to reliably prevent the change of characteristics due to the minute dimension change accompanied by the temperature change, and thus it is possible to improve the temperature characteristics of the ball bearing 61 and the yo-yo 2. Furthermore, it is also possible to further improve the temperature characteristics by forming the bush 85 by the same material.

In addition, it is evident that the bearing units 10 and 60, ball bearings 11 and 61 or the yo-yos 1 and 2 of the embodiments can be changed and applied in various forms, without being limited to the configuration mentioned above. Although the specific embodiments of the present invention have been described in detail, it is obvious to those skilled in the art that various alternations and modifications can be added without departing from the gist and the scope of the present invention.

As mentioned above, although the specific embodiments of the present invention have been described in detail, it is obvious to those skilled in the art that various alternations and modifications can be added without departing from the gist and the scope of the present invention. The present invention contains subject matter according to Japanese Patent Application No. 2011-279701 filed with the Japanese Patent Office on Dec. 21, 2011, the entire contents of which are incorporated herein by reference.

### INDUSTRIAL APPLICABILITY

The ball bearing of the present invention can be applied to the rotary toy such as the yo-yo, and is useful since assembling can simply and accurately be performed even if performing disassembling or assembling.

Furthermore, the ball bearing of the present invention can be applied to the rotary toy such as the yo-yo, and is useful since it is possible to improve workability in disassembling and assembling.

### REFERENCE SIGNS LIST

1, 2 yo-yo
10, 60 bearing unit
11, 61 ball bearing
12, 62 inner ring
13, 63 outer ring
14, 64 ball
15, 65 shaft
16, 66 center portion
17, 67 tapered portion
18, 68 screw
19, 69 center hole
30, 80 halves
33, 83 friction plate
35, 85 bush
36, 86 inner diameter portion
37, 87 nut
40, 90 inertia ring
71 concave surface
72 flat surface
51 ball bearing
52 screw
53 halves
53a inner diameter portion
54 fitting portion
161 ball bearing
162 inner ring
163 outer ring
164 ball
171 concave surface

1. A bearing unit for a rotary toy, comprising:
a shaft comprising:
a center portion having a uniform shaft diameter corresponding to a width of an inner ring of a ball bearing; and
tapered portions each extending from the center portion, each of the tapered portions being tapered toward an end portion thereof,
wherein the central portion of the shaft is fixed to the inner ring.

2. The bearing unit of claim 1, wherein the center portion of the shaft is fixed to the inner ring by interference fit, and a value of the interference fit is smaller than a radial gap of the ball bearing.

3. The bearing unit of claim 1,
wherein a gap is formed between the center portion of the shaft and the inner ring, and the center portion of the shaft is fixed to the inner ring by an adhesive filled in the gap, and
wherein the adhesive comprises a filler whose size is smaller than a radial gap of the ball bearing.

4. The bearing unit of claim 1,
wherein the ball bearing further comprises an outer ring, and
the inner ring and the outer ring are made of martensitic stainless steel.

5. A yo-yo comprising:
the bearing unit of claim 1; and
halves each fitted with a corresponding one of the tapered portions.

6. The yo-yo according to claim 5, wherein the halves are removable from the bearing unit via a clamping means.

7. The yo-yo of claim 5,
wherein each of the halves comprises a bush at a portion where each of the halves is fitted with the corresponding tapered portion, wherein the hardness of the bush is higher than that of the halves.

8. The yo-yo of claim 7, wherein the bush is made of martensitic stainless steel.

9. A ball bearing for a rotary toy, comprising:
an inner ring;
an outer ring;
wherein a concave surface is formed on an outer peripheral surface of the outer ring,
the concave surface has the smallest outer diameter at an axial center position of the outer ring, and has a linear symmetric shape at the axial center position, and
flat surfaces are formed at both axial sides of the concave surface such that the respective flat surfaces are perpendicular to end surfaces of the outer ring.

10. The bearing unit of claim 9, wherein an axial center portion of the concave surface is formed in a parabolic shape or an arc shape.

11. The bearing unit of claim 9,
wherein the inner ring and the outer ring are made of martensitic stainless steel.

12. A yo-yo comprising:
the ball bearing of claim 9; and
halves provided at axial both sides of the ball bearing.

13. The yo-yo of claim 12, wherein the halves are removable from the ball bearing.
